(19) United States
(12) Patent Application Publication
(10) Pub. No.: US 2025/0099327 A1
(43) Pub. Date: Mar. 27, 2025

(54) ACOUSTIC SHOCK WAVE THERAPEUTIC METHODS TO CORRECT ARRHYTHMIA

(71) Applicant: Tissue Regeneration Technologies, LLC, Kennesaw, GA (US)

(72) Inventor: John F. Warlick, Kennesaw, GA (US)

(21) Appl. No.: 18/472,609

(22) Filed: Sep. 22, 2023

(51) Int. Cl. A61H 31/00

(52) U.S. Cl. CPC A61H 31/006; A61H 2201/1654; A61H 2230/06

(57) ABSTRACT

A treatment method to reduce or eliminate a patient's symptoms of irregular heart rhythm, atrial fibrillation, or abnormal heart rhythm; the treatment has the step of: administering acoustic shock waves or pressure pulses directed to an area near the patient's heart or chest. The treatment method further has the steps of: activating acoustic shock waves or pressure pulses of an acoustic shock wave or pressure pulse generator to emit acoustic shock waves or pressure pulses; subjecting the area at or near the heart or chest to acoustic shock waves or pressure pulses stimulating the area; and wherein the emitted acoustic shock waves or pressure pulses are focused or unfocused acoustic shock waves or pressure pulses.

### FIELD OF THE INVENTION

The present invention relates to an improved treatment method of utilizing acoustic shock waves or pressure pulses to treat irregular heart rhythm, atrial fibrillation (A-Fib) and similar pathologies by restoring rhythm by resetting neurological pathways and reducing inflammation.

### BACKGROUND OF THE INVENTION

An abnormal heart rhythm or arrhythmia includes conditions where the heart beats too fast, too slow, or irregularly. The most common arrhythmia is atrial fibrillation (AFib) which occurs when many unstable electrical impulses misfire and cause the heart to beat irregularly and can drastically increase the heart rate.

An abnormal heart rhythm can cause some or all of these symptoms: feeling faint, dizzy, or lightheaded; shortness of breath; irregular pulse or heart palpitations; chest pain; pale skin; sweating; fainting; and fatigue. Factors that can cause abnormal heart rhythms include: high blood pressure, coronary heart disease, heart conditions, medications, anxiety, illness, pain, electrolyte imbalances, etc.

For abnormalities that do not respond to behavioral changes or medication, other treatments include: electrical shock to the heart, catheter ablation, pacemaker or surgery.

In U.S. Pat. No. 7,470,240 B2, entitled “Pressure Pulse/Shock Wave Therapy Methods And An Apparatus For Conducting The Therapeutic Methods”, is disclosed a novel use of unfocused shock waves to stimulate a cellular substance. From this patent a family of treatment patents evolved. The list includes U.S. Pat. Nos. 7,841,995; 7,883,482; 7,905,845 all divisional applications; and U.S. Pat. No. 7,507,213 entitled “Pressure Pulse/Shock Wave Therapy Methods For Organs”; U.S. Pat. No. 7,544,171 B2 entitled “Methods for Promoting Nerve Regeneration and Neuronal Growth and Elongation”; U.S. Pat. No. 7,988,648 B2 entitled “Pancreas Regeneration Treatment For Diabetics Using Extracorporeal Acoustic shock waves or pressure pulses”; all teaching a new useful way to deliver acoustic shock waves or pressure pulses to achieve a healing response. Each of these patents are incorporated herein by reference in their entirety. In addition, patents U.S. Pat. Nos. 8,257,282 and 8,535,249 for the device to perform these methods by delivering low energy unfocused acoustic shock waves or pressure pulses to the cellular tissue being treated.

While this large volume of research has been rewarded by the granting of numerous patents, much new work has been evolving as the understanding of the technology is being applied. It is in this latest work that some, heretofore, unknown improvements and refinements have been discovered that were hidden from and unappreciated by scientists in this field. In particular, the use of acoustic shock waves or pressure pulses to treat abnormal heart rhythms.

### SUMMARY OF THE INVENTION

A treatment method to reduce or eliminate a patient's symptoms of irregular heart rhythm, atrial fibrillation, or abnormal heart rhythm; the treatment has the step of: administering acoustic shock waves or pressure pulses directed to an area near the patient's heart or chest. The treatment method further has the steps of: activating acoustic shock waves or pressure pulses of an acoustic shock wave or pressure pulse generator to emit acoustic shock waves or pressure pulses; subjecting the area at or near the heart or chest to acoustic shock waves or pressure pulses stimulating the area; and wherein the emitted acoustic shock waves or pressure pulses are focused or unfocused acoustic shock waves or pressure pulses.

The treatment method further has the steps of: attaching or otherwise connecting an electrocardiogram monitoring device to the patient suspected of having an irregular heartbeat; activating the electrocardiogram monitoring device and observing the heartbeat pattern and confirming an irregular heartbeat pattern exists; observing the heartbeat pattern on the electrocardiogram monitoring device while administering acoustic shock waves or pressure pulses directed to an area near the patient's heart or chest; and stop administering the acoustic shock waves or pressure pulses when the heartbeat pattern being observed is changed to a regular heartbeat pattern as displayed on the electrocardiogram monitoring device.

The treatment method, further has the steps of: having the patient wear a portable heart monitor after the treatment to look for a recurrence of any irregular heartbeat patterns for a period of a few days or more; and if a recurrence occurs, repeat the administering of the shock waves or pressure pulses to reset the irregular heartbeat pattern to a regular heartbeat pattern.

The shock wave or pressure pulse generator is acoustically coupled to the patient's skin using a coupling gel or liquid. The stimulating of the area causes a release of nitric oxide, secretion of digestive enzymes, hormones and other fluids reduces inflammation and absorbs plaque. The stimulating of the area also causes a release of growth factors including, but not limited to VEGF and causes new blood vessels to be created increasing vascularization.

The treatment method can be repeated one or more times prior to or during the medical procedure or after the medical procedure. Each subjected area receives between 100 and 2000 acoustic shock waves or pressure pulses per therapy session. The number of repeated treatments occur on a schedule over a period of three or more weeks, and treatments can be repeated over time as an irregular heartbeat prevention protocol over longer durations of time between repeated treatments.

The emitted acoustic shock waves or pressure pulses are low energy soft waves. The low energy soft waves have an energy density in the range of 0.01 mJ/mm² to 1.0 mJ/mm². Preferably, the low energy soft waves have an energy density in the range of 0.04 mJ/mm² to 0.3 mJ/mm². Alternatively, the emitted acoustic shock waves or pressure pulses have an energy density in the range of 0.01 mJ/mm² to 50 mJ/mm². The emitted acoustic shock waves or pressure pulses are spherical, radial, convergent, divergent, planar, near planar, focused or unfocused from a source with or without a lens that is one of electrohydraulic, electromagnetic, piezoelectric, ballistic or water jets configured to produce an acoustic shock wave and wherein the acoustic shock waves or pressure pulses are administered invasively or noninvasively.

An alternative treatment method to reduce or eliminate a patient's symptoms of irregular heart rhythm, atrial fibrillation, or abnormal heart rhythm; the treatment has the steps of: attaching or otherwise connecting an electrocardiogram monitoring device to the patient suspected of having an irregular heartbeat; activating the electrocardiogram monitoring device and observing the heartbeat pattern and confirming an irregular heartbeat pattern exists; administering acoustic shock waves or pressure pulses directed to an area near the patient's heart or chest while observing the heartbeat pattern on the electrocardiogram monitoring device; and stop administering the acoustic shock waves or pressure pulses when the heartbeat pattern being observed is changed to a regular heartbeat pattern as displayed on the electrocardiogram monitoring device. The method further has the steps of: having the patient wear a portable heart monitor after the treatment to look for a recurrence of any irregular heartbeat patterns for a period of a few days or more; and if a recurrence occurs, repeat the administering of the shock waves or pressure pulses to reset the irregular heartbeat pattern to a regular heartbeat pattern.

### DEFINITIONS

“Ablation” is a procedure to treat atrial fibrillation. It uses heat (radiofrequency energy) or cold energy (cryoablation) to create tiny scars in the heart to block the faulty electrical signals and restore a typical heartbeat. This can help the heart maintain a normal heart rhythm. Possible ablation risks include: bleeding or infection at the site where the catheters were inserted; blood vessel damage; heart valve damage; new or worsening irregular heartbeats (arrhythmias); slow heart rate that could require a pacemaker to correct; blood clots in the legs or lungs (venous thromboembolism); stroke or heart attack, narrowing of the veins that carry blood between the lungs and heart (pulmonary vein stenosis); or damage to the kidneys from contrast dye used during the procedure.

The term “arrhythmia” refers to any problem in the rate or rhythm of a person's heartbeat. During an arrhythmia, the electrical impulses may be too fast, too slow or erratic causing an irregular heartbeat.

“Atrial fibrillation” is an abnormal heart rhythm characterized by rapid and irregular beating of the atrial chambers of the heart. It often begins as short periods of abnormal beating, which become longer or continuous over time. It may also start as other forms of arrhythmia such as atrial flutter that then transform into AF.

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having a curved emitting surfaces generally produce wave having divergent wave fronts.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

“Extracorporeal” means occurring or based outside the living body.

A “generalized paraboloid” according to the present invention is also a three-dimensional bowl. In two dimensions (in Cartesian coordinates, x and y) the formula yn=2px [with n being ≠2, but being greater than about 1.2 and smaller than 2, or greater than 2 but smaller than about 2.8]. In a generalized paraboloid, the characteristics of the wave fronts created by electrodes located within the generalized paraboloid may be corrected by the selection of (p (−z,+z)), with z being a measure for the burn down of an electrode, and n, so that phenomena including, but not limited to, burn down of the tip of an electrode (−z,+z) and/or disturbances caused by diffraction at the aperture of the paraboloid are compensated for.

A “paraboloid” according to the present invention is a three-dimensional reflecting bowl. In two dimensions (in Cartesian coordinates, x and y) the formula y2=2 px, wherein p/2 is the distance of the focal point of the paraboloid from its apex, defines the paraboloid. Rotation of the two-dimensional figure defined by this formula around its longitudinal axis generates a de facto paraboloid.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nanoseconds (ns) up to some milliseconds (ms). Very fast pressure pulses are called shock waves. Shock waves used in medical applications do have amplitudes above 0.1 MPa and rise times of the amplitude can be below 1000 ns, preferably at or below 100 ns. The duration of a shock wave is typically below 1-3 microseconds (us) for the positive part of a cycle and typically above some microseconds for the negative part of a cycle.

“Shock Wave”: As used herein is defined by Camilo Perez, Hong Chen, and Thomas J. Matula; Center for Industrial and Medical Ultrasound, Applied Physics Laboratory, University of Washington, 1013 NE 40th Street, Seattle, Washington 98105; Maria Karzova and Vera A. Khokhlovab; Department of Acoustics, Faculty of Physics, Moscow State University, Moscow 119991, Russia; (Received 9 Oct. 2012; revised 16 Apr. 2013; accepted 1 May 2013) in their publication, “Acoustic field characterization of the Duolith: Measurements and modeling of a clinical shock wave therapy device”; incorporated by reference herein in its entirety.

Waves/wave fronts described as being “focused” or “having focusing characteristics” means in the context of the present invention that the respective waves or wave fronts are traveling and increase their amplitude in direction of the focal point. Per definition the energy of the wave will be at a maximum in the focal point or, if there is a focal shift in this point, the energy is at a maximum near the geometrical focal point. Both the maximum energy and the maximal pressure amplitude may be used to define the focal point.

### BRIEF DESCRIPTION OF THE DRAWINGS

The invention will be described by way of example and with reference to the accompanying drawings in which:

FIG. 1 is a simplified depiction of a pressure pulse/shock wave (PP/SW) generator with focusing wave characteristics.

FIG. 2 is a simplified depiction of a pressure pulse/shock wave generator with plane wave characteristics.

FIG. 3 is a simplified depiction of a pressure pulse/shock wave generator with divergent wave characteristics.

FIG. 4 is a simplified depiction of a pressure pulse/shock wave generator connected to a control/power supply unit.

FIG. 5 is a graph showing an exemplary ultrasound wave pattern.

FIG. 6 is a graph of an exemplary acoustic shock wave pattern.

FIG. 7 shows a patient being attached or otherwise connected to an electrocardiogram device so real time heart rate patterns can be observed during the treatment.

FIG. 8 is an exemplary chart of a heartbeat pattern exhibiting an irregular heartbeat.

FIG. 9 is an exemplary chart of a regular or normal heartbeat pattern.

### DETAILED DESCRIPTION OF THE INVENTION

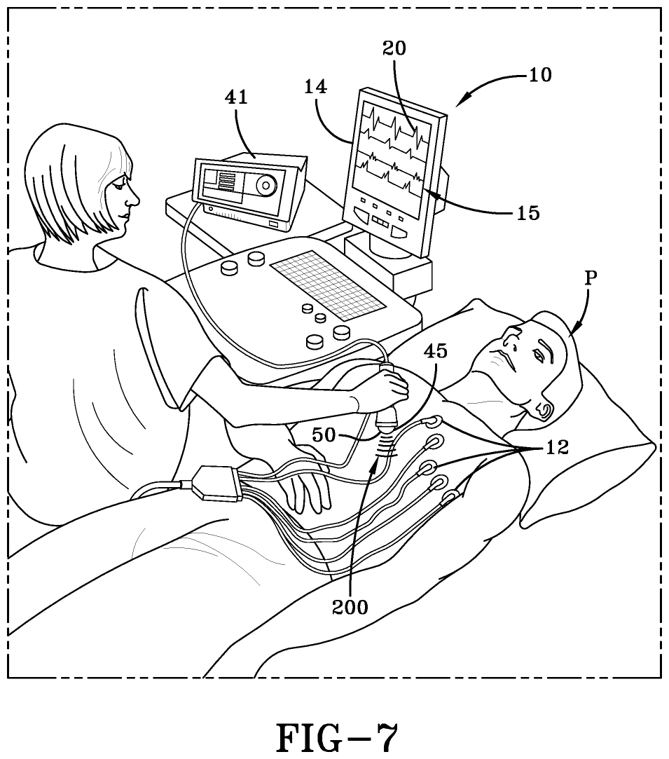

With reference to FIGS. 7-9, a treatment method to reduce or eliminate a patient's symptoms of irregular heartbeat rhythm, arterial fibrillation or abnormal heart rhythm has the steps of administering acoustic shock waves or pressure pulses directed to an area near the patient's heart or chest is illustrated.

FIG. 7 is a depiction of an acoustic shock wave treatment to a region of the chest 100 of a patient P to affect the heartbeat pattern which also will reduce plaque or swelling or inflammation. The acoustic shock waves 200 are transmitted into the region 100 as shown. In this example, the patient P has the shock wave applicator 43 positioned against the surface of the chest 100. This surface contact between the applicator 43 and the chest 100 can be enhanced by the use of an acoustic gel 50 that couples the applicator head membrane 45 to the skin of the patient. Upon activating the acoustic shock wave or pressure pulse device 41, shock waves 200 are transmitted through the rib cage and into the heart area. These shock waves 200 will stimulate the reflex action of the heart such that the irregular heartbeat pattern is shocked acoustically in such a fashion that the irregular heartbeat is reset so that it is converted to a regular heartbeat pattern or normal heartbeat in the absence of any irregularity in the heartbeat pattern.

As shown in FIG. 7, this procedure can be applied to a patient P who is coupled or otherwise attached to an electrocardiogram device 10 in such a fashion that the sensors 12 placed adhesively against the skin Ps of the patient P around the chest area can pick up the heartbeat pattern 20 in real time and transmit the heartbeat pattern 20 to a monitor 14 which can be visually observed by the operator of the shock wave device 41. The operator can start administering shock waves 200 and they will observe that the shock waves 200 as they enter into the chest cavity have an effect on the heartbeat pattern 20 such that the irregular heartbeat is directed to the positioned more normally in line such that the irregularity is corrected or dissipated in real time as the shock waves 200 are being administered. This can be confirmed by visually observing the electrocardiogram chart 15. After the shock waves 200 have been administered, the operator can continue to observe the electrocardiogram device 10 to ensure that the irregular heartbeat does not come back within a short period of time. Once the operator has confirmed that they have reset the heartbeat pattern 20, the treatment can be discontinued. If on the other hand, the irregular heartbeat comes back, a second administration of shock waves 200 can be directed to the chest area 100 to attempt to reset the heartbeat rhythm to normal. Again, observation of all this occurs while the patient P is hooked to the electrocardiogram device 10 so that the operator can see the effects of the shock waves as the treatment is occurring. This is unique in that it requires no medication, no treatments or no dwell time or waiting time to confirm that the irregular heartbeat has been corrected. After a period of time, the patient P can be either continually monitored using a heart monitor device once the patient is released which can then be checked for irregularities or will indicate when an irregularity occurs. If no irregularities occur over a period of time, it is safe to assume that the patient's irregular heartbeat has been corrected.

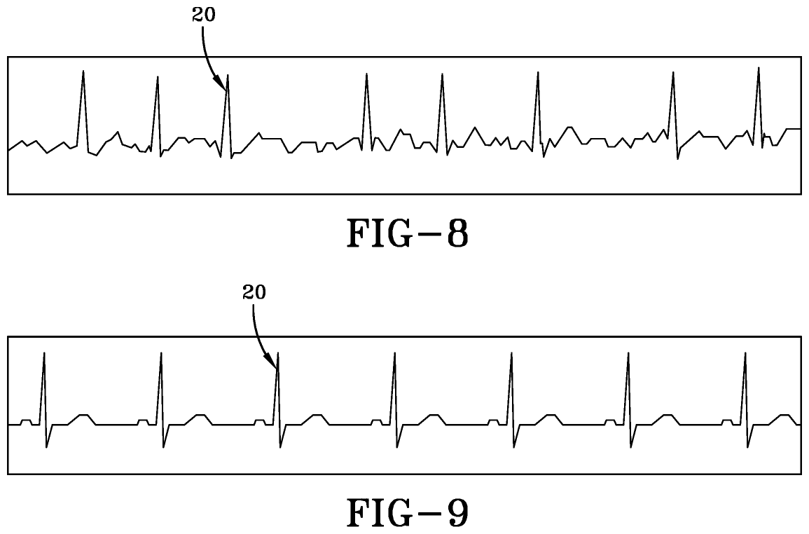

To further facilitate understanding the present invention, FIG. 8 shows a chart of an irregular heartbeat pattern 20. FIG. 9 shows a regular heartbeat pattern 20 wherein the heartbeat pattern 20 has no wave forms that are inconsistent with normal or regular heartbeats. It is the objective of the present invention to take patients with irregular heartbeats and to convert them to patients having normal or regular heartbeats without any arrythmia.

The electrocardiogram device 10 can be any heart monitoring device that displays the heartbeat pattern which can include a phone application with a monitoring card, portable heart monitor, wearable heart monitor or any other device that is connected in some way to the patient to display or show the heartbeat pattern. It is this heartbeat pattern that will be observed while the acoustic shock waves or pressure pulses are being administered to the patient to correct any heartbeat irregularities or arrythmia.

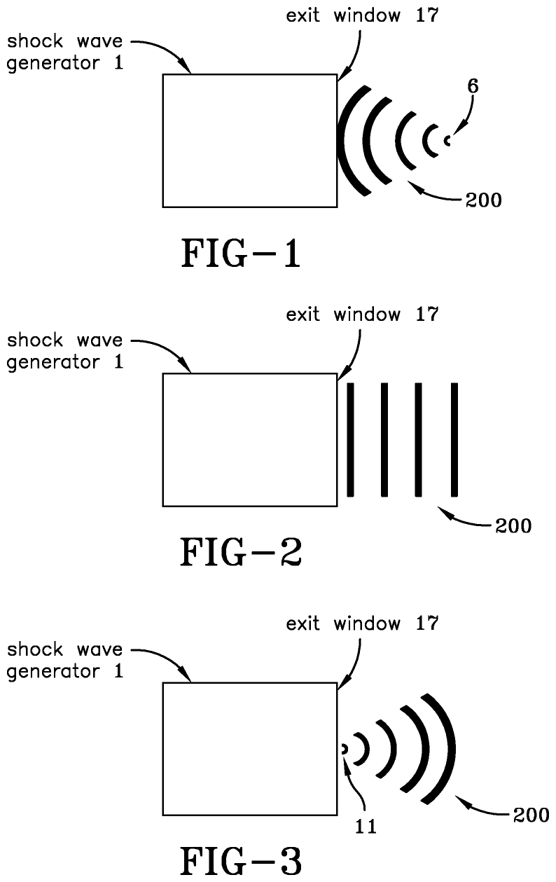

With reference to FIGS. 1-3, a variety of schematic views of acoustic shock waves or pressure pulses are described. The following description of the proper amplitude and pressure pulse intensities of the shock waves are provided along with a description of how the shock waves actually function. For the purpose of describing, the shock waves were used as exemplary and are intended to include all of the wave patterns discussed in the figures as possible treatment patterns for treating patients suspected of having irregular heartbeat patterns.

FIG. 1 is a simplified depiction of a pressure pulse/shock wave (PP/SW) generator, such as a shock wave head, showing focusing characteristics of transmitted acoustic pressure pulses. Numeral 1 indicates the position of a generalized pressure pulse generator, which generates the pressure pulse and, via a focusing element, focuses it outside the housing to treat diseases. The affected tissue or organ is generally located in or near the focal point which is located in or near position 6. At position 17 a water cushion or any other kind of exit window for the acoustical energy is located.

FIG. 2 is a simplified depiction of a pressure pulse/shock wave generator, such as a shock wave head, with plane wave characteristics. Numeral 1 indicates the position of a pressure pulse generator according to the present invention, which generates a pressure pulse which is leaving the housing at the position 17, which may be a water cushion or any other kind of exit window. Somewhat even, also referred to herein as “disturbed”, wave characteristics can be generated, in case a paraboloid is used as a reflecting element, with a point source (e.g. electrode) that is located in the focal point of the paraboloid. The waves will be transmitted into the patient's body via a coupling media such as, e.g., ultrasound gel or oil and their amplitudes will be attenuated with increasing distance from the exit window 17.

FIG. 3 is a simplified depiction of a pressure pulse shock wave generator (shock wave head) with divergent wave characteristics. The divergent wave fronts may be leaving the exit window 17 at point 11 where the amplitude of the wave front is very high. This point 17 could be regarded as the source point for the pressure pulses. In FIG. 3, the pressure pulse source may be a point source, that is, the pressure pulse may be generated by an electrical discharge of an electrode under water between electrode tips. However, the pressure pulse may also be generated, for example, by an explosion, referred to as a ballistic pressure pulse. The divergent characteristics of the wave front may be a consequence of the mechanical setup.

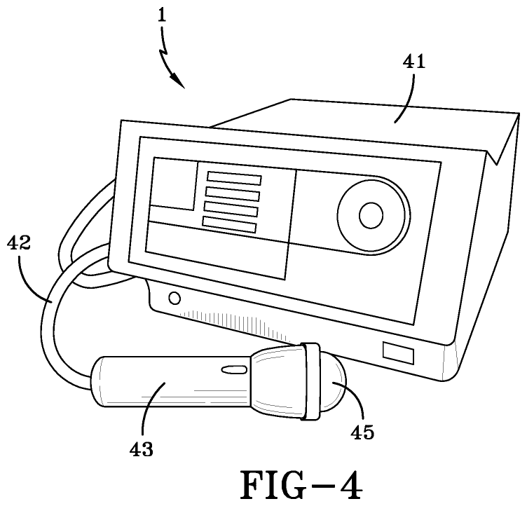

With reference to FIG. 4, an exemplary acoustic shock wave apparatus 1 is illustrated. The shock wave apparatus 1 has a generator 41 connected by a flexible hose with fluid conduits extending from the shock wave generator 41 to an applicator 43 which transmits the acoustic waves when coupled to the skin by using a fluid or acoustic gel. The applicator 43 as illustrated has a body that enables a technician to hold the applicator 43 and as illustrated this applicator is an electrohydraulic that is filled with fluid to facilitate the transmission of the shock waves. The fluid expands a flexible membrane 45 in such a fashion that the membrane 45 extends outwardly in a balloon shape fashion as illustrated in FIG. 4. As shown, this type of applicator 43 has a hydraulic spark generator using either focused or unfocused shock waves, preferably in a low energy level, less than the range of 0.01 mJ/mm² to 0.3 mJ/mm². The flexible hose 42 is connected to a fluid supply that fills the applicator 43 and expands the flexible membrane 45 when filled. Alternatively, a ballistic, piezoelectric or spherical acoustic shock wave device can be used to generate the desired waves.

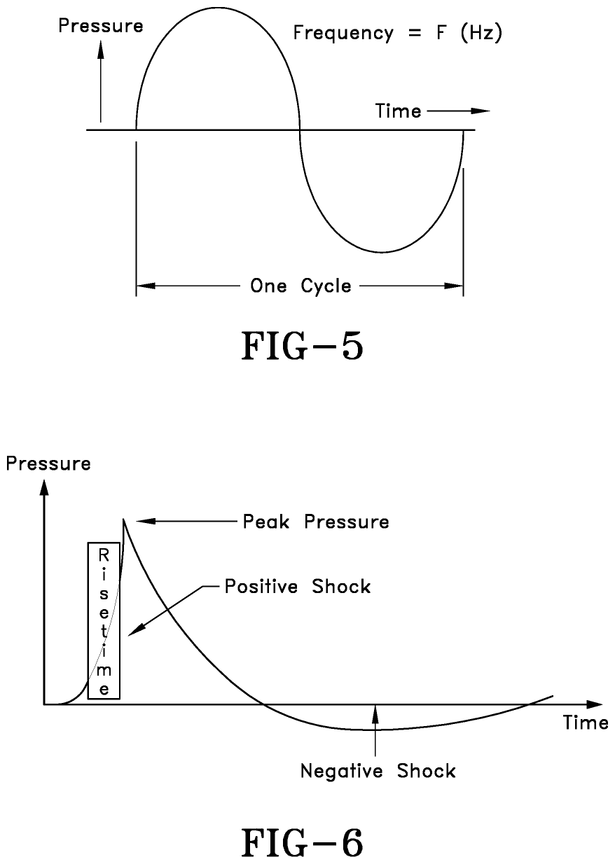

The ultrasonic wave pattern shown in FIG. 5 is contrasted to an asymmetric acoustic wave pattern which is illustrated in FIG. 6. As shown, ultrasound waves are symmetrical having the positive rise time equal to the negative in a sinusoidal wave form. These ultrasound waves generate heat in the tissue and are accordingly believed not suitable for use on organs or sensitive tissue, more particularly these symmetrical waves would have no impact on a heartbeat pattern.

This apparatus, in certain embodiments, may be adjusted/modified/or the complete shock wave head or part of it may be exchanged so that the desired and/or optimal acoustic profile such as one having wave fronts with focused, planar, nearly plane, convergent or divergent characteristics can be chosen.

A change of the wave front characteristics may, for example, be achieved by changing the distance of the exit acoustic window relative to the reflector, by changing the reflector geometry, by introducing certain lenses or by removing elements such as lenses that modify the waves produced by a pressure pulse/shock wave generating element. Exemplary pressure pulse/shock wave sources that can, for example, be exchanged for each other to allow an apparatus to generate waves having different wave front characteristics are described in detail below.

In certain embodiments, the change of the distance of the exit acoustic window can be accomplished by a sliding movement. However, in other embodiments of the present invention, in particular, if mechanical complex arrangements, the movement can be an exchange of mechanical elements.

In one embodiment, mechanical elements that are exchanged to achieve a change in wave front characteristics include the primary pressure pulse generating element, the focusing element, the reflecting element, the housing and the membrane. In another embodiment, the mechanical elements further include a closed fluid volume within the housing in which the pressure pulse is formed and transmitted through the exit window.

In one embodiment, the apparatus of the present invention is used in combination therapy. Here, the characteristics of waves emitted by the apparatus are switched from, for example, focused to divergent or from divergent with lower energy density to divergent with higher energy density. Thus, effects of a pressure pulse treatment can be optimized by using waves having different characteristics and/or energy densities, respectively.

While the above described universal toolbox of the present invention provides versatility, the person skilled in the art will appreciate that apparatuses that only produce waves having, for example, nearly plane characteristics, are less mechanically demanding and fulfill the requirements of many users.

As the person skilled in the art will also appreciate that embodiments shown in the drawings are independent of the generation principle and thus are valid for not only electro-hydraulic shock wave generation but also for, but not limited to, PP/SW generation based on electromagnetic, piezoceramic and ballistic principles. The pressure pulse generators may, in certain embodiments, be equipped with a water cushion that houses water which defines the path of pressure pulse waves that is, through which those waves are transmitted. In a preferred embodiment, a patient is coupled via ultrasound gel or oil to the acoustic exit window 17, which can, for example, be an acoustic transparent membrane 45, a water cushion, a plastic plate or a metal plate.

These shock wave energy transmissions are effective in stimulating a cellular response and can be accomplished without creating the cavitation bubbles in the tissue of the target site when employed in other than site targeted high energy focused transmissions. This effectively insures the tissue does not have to experience the sensation of hemorrhaging so common in the higher energy focused wave forms having a focal point at or within the targeted treatment site. Bleeding internally causes an increase in fluid pressure which can lead to increased damage. This can be completely avoided in this treatment protocol.

The fact that some if not all of the dosage can be at a low energy the common problem of localized hemorrhaging is reduced making it more practical to administer multiple dosages of waves from various orientations near the heart to further optimize the treatment and cellular stimulation of the target site. Heretofore focused high energy multiple treatments induced pain and discomfort to the patient. The use of low energy focused or unfocused waves at the target site enables multiple sequential treatments.

The present method may need precise site location and can be used in combination with such known devices as ultrasound, cat-scan or x-ray imaging if needed. The physician's general understanding of the anatomy of the patient may be sufficient to locate the target area to be treated. This is particularly true when the device is visually within the surgeon's line of sight, and this permits the lens or cover of the emitting shock wave source to impinge on the affected tissue directly through a transmission enhancing gel, water or fluid medium during the pressure pulse or shock wave treatment. The treated area can withstand a far greater number of shock waves based on the selected energy level being emitted. For example, at very low energy levels the stimulation exposure can be provided over prolonged periods of as much as 20 minutes if so desired. At higher energy levels the treatment duration can be shortened to less than a minute, less than a second if so desired. The limiting factor in the selected treatment dosage is avoidance or minimization of surrounding cell hemorrhaging and other kinds of damage to the surrounding cells or tissue while still providing a stimulating stem cell activation or a cellular release or activation of proteins such as VEGF and other growth factors.

Due to the wide range of beneficial treatments available it is believed preferable that the optimal use of one or more wave generators or sources should be selected on the basis of the specific application. A key advantage of the present inventive methodology is that it is complimentary to conventional medical procedures. In the case of any operative surgical procedure the surgical area of the patient can be bombarded with these energy waves to stimulate cellular release of healing agents and growth factors. This will dramatically reduce the healing process time. Most preferably such patients may be provided more than one such treatment with an intervening dwell time for cellular relaxation prior to secondary and tertiary post operative treatments.

The underlying principle of these pressure pulse or shock wave therapy methods is to enrich the treatment area directly and to stimulate the body's own natural healing capability. This is accomplished by deploying shock waves to stimulate strong cells in the surrounding tissue to activate a variety of responses. The acoustic shock waves transmit or trigger what appears to be a cellular communication throughout the entire anatomical structure, this activates a generalized cellular response at the treatment site, in particular, but more interestingly a systemic response in areas more removed from the wave form pattern. This is believed to be one of the reasons molecular stimulation can be conducted at threshold energies heretofore believed to be well below those commonly accepted as required. Accordingly, not only can the energy intensity be reduced in some cases, but also the number of applied shock wave impulses can be lowered from several thousand to as few as one or more pulses and still yield a beneficial stimulating response. The key is to provide at least a sufficient amount of energy to activate healing reactions.

The use of shock waves as described above appears to involve factors such as thermal heating, light emission, electromagnetic field exposure, chemical releases in the cells as well as a microbiological response within the cells.

The unfocused shock waves can be of a divergent wave pattern, planar or near planar pattern preferably convergent diffused or far-sighted wave pattern, of a low peak pressure amplitude and density. Typically, the energy density values range as low as 0.000001 mJ/mm² and having a high end energy density of below 1.0 mJ/mm², preferably 0.20 mJ/mm² or less. The peak pressure amplitude of the positive part of the cycle should be above 1.0 and its duration is below 1-3 microseconds.

The treatment depth can vary from the surface to the full depth of the treated organ. The treatment site can be defined by a much larger treatment area than the 0.10-3.0 cm² commonly produced by focused waves. The above methodology is particularly well suited for surface as well as sub-surface soft tissue organ treatments like the heart.

While the above listed indications cited above are not exhaustive nor intended to be limiting, it is exemplary of the wide range of beneficial uses of high energy focused or low energy and amplitude unfocused divergent, planar or nearly planar shock waves, convergent shock waves, diffused shock waves or a combination of shock wave types in the treatment of humans and other mammals.

The biological model motivated the design of sources with low pressure amplitudes and energy densities. First: spherical waves generated between two tips of an electrode; and second: nearly even waves generated by generalized parabolic reflectors. Third: divergent shock front characteristics are generated by an ellipsoid behind f2. Unfocused sources are preferably designed for extended two dimensional areas/volumes like skin. The unfocused sources can provide a divergent wave pattern a planar or a nearly planar wave pattern and can be used in isolation or in combination with focused wave patterns yielding to an improved therapeutic treatment capability that is non-invasive with few if any disadvantageous contraindications. Alternatively, a focused wave emitting treatment may be used wherein the focal point extends preferably beyond the target treatment site, potentially external to the patient. This results in the reduction of or elimination of a localized intensity zone with associated noticeable pain effect while providing a wide or enlarged treatment volume at a variety of depths more closely associated with high energy focused wave treatment. The utilization of a diffuser type lens or a shifted far-sighted focal point for the ellipsoidal reflector enables the spreading of the wave energy to effectively create a convergent but off target focal point. This insures less tissue trauma while insuring cellular stimulation to enhance the healing process and control the migration or spreading of the infection within the host.

It will be appreciated that the apparatuses and processes of the present invention can have a variety of embodiments, only a few of which are disclosed herein. It will be apparent to the artisan that other embodiments exist and do not depart from the spirit of the invention. Thus, the described embodiments are illustrative and should not be construed as restrictive.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A treatment method to reduce or eliminate a patient's symptoms of irregular heart rhythm, atrial fibrillation, or abnormal heart rhythm; the treatment comprises the step of:
administering acoustic shock waves or pressure pulses directed to an area near the patient's heart or chest.

2. The treatment method of claim 1, further comprises the steps of:
activating acoustic shock waves or pressure pulses of an acoustic shock wave or pressure pulse generator to emit acoustic shock waves or pressure pulses;
subjecting the area at or near the heart or chest to acoustic shock waves or pressure pulses stimulating the area; and
wherein the emitted acoustic shock waves or pressure pulses are focused or unfocused acoustic shock waves or pressure pulses.

3. The treatment method of claim 1, further comprises the steps of:
attaching or otherwise connecting an electrocardiogram monitoring device to the patient suspected of having an irregular heartbeat;
activating the electrocardiogram monitoring device and observing the heartbeat pattern and confirming an irregular heartbeat pattern exists;
observing the heartbeat pattern on the electrocardiogram monitoring device while administering acoustic shock waves or pressure pulses directed to an area near the patient's heart or chest; and
stop administering the acoustic shock waves or pressure pulses when the heartbeat pattern being observed is changed to a regular heartbeat pattern as displayed on the electrocardiogram monitoring device.

4. The treatment method of claim 3, further comprises the steps of:
having the patient wear a portable heart monitor after the treatment to look for a recurrence of any irregular heartbeat patterns for a period of a few days or more; and
if a recurrence occurs, repeat the administering of the shock waves or pressure pulses to reset the irregular heartbeat pattern to a regular heartbeat pattern.

5. The treatment method of claim 1, wherein the shock wave or pressure pulse generator is acoustically coupled to the patient's skin using a coupling gel or liquid.

6. The treatment method of claim 1, wherein the stimulating of the area causes a release of nitric oxide, secretion of digestive enzymes, hormones and other fluids reduces inflammation and absorbs plaque.

7. The treatment method of claim 6, wherein the stimulating of the area causes a release of growth factors including, but not limited to VEGF.

8. The treatment method of claim 7, wherein the stimulating of the area causes new blood vessels to be created increasing vascularization.

9. The treatment method of claim 2, is repeated one or more times prior to or during the medical procedure or after the medical procedure.

10. The treatment method of claim 2, wherein the emitted acoustic shock waves or pressure pulses are low energy soft waves.

11. The treatment method of claim 10, wherein the low energy soft waves have an energy density in the range of 0.01 mJ/mm² to 1.0 mJ/mm².

12. The treatment method of claim 11, wherein the low energy soft waves have an energy density in the range of 0.04 mJ/mm² to 0.3 mJ/mm².

13. The treatment method of claim 2, wherein each subjected area receives between 100 and 2000 acoustic shock waves or pressure pulses per therapy session.

14. The treatment method of claim 2, wherein the emitted acoustic shock waves or pressure pulses are spherical, radial, convergent, divergent, planar, near planar, focused or unfocused from a source with or without a lens that is one of electrohydraulic, electromagnetic, piezoelectric, ballistic or water jets configured to produce an acoustic shock wave and wherein the acoustic shock waves or pressure pulses are administered invasively or noninvasively.

15. The treatment method of claim 9, wherein the number of repeated treatments occur on a schedule over a period of three or more weeks, and treatments can be repeated over time as an irregular heartbeat prevention protocol over longer durations of time between repeated treatments.

16. The treatment method of claim 2, wherein the emitted acoustic shock waves or pressure pulses have an energy density in the range of 0.01 mJ/mm² to 50 mJ/mm².

17. A treatment method to reduce or eliminate a patient's symptoms of irregular heart rhythm, atrial fibrillation, or abnormal heart rhythm; the treatment comprises the steps of:
attaching or otherwise connecting an electrocardiogram monitoring device to the patient suspected of having an irregular heartbeat;
activating the electrocardiogram monitoring device and observing the heartbeat pattern and confirming an irregular heartbeat pattern exists;
administering acoustic shock waves or pressure pulses directed to an area near the patient's heart or chest while observing the heartbeat pattern on the electrocardiogram monitoring device; and
stop administering the acoustic shock waves or pressure pulses when the heartbeat pattern being observed is changed to a regular heartbeat pattern as displayed on the electrocardiogram monitoring device.

18. The method of claim 17 further comprises the steps of:
having the patient wear a portable heart monitor after the treatment to look for a recurrence of any irregular heartbeat patterns for a period of a few days or more; and
if a recurrence occurs, repeat the administering of the shock waves or pressure pulses to reset the irregular heartbeat pattern to a regular heartbeat pattern.
